(19) United States
(12) Patent Application Publication
(10) Pub. No.: US 2018/0222139 A1
(43) Pub. Date: Aug. 9, 2018

(54) TIRE VULCANIZER

(71) Applicant: MITSUBISHI HEAVY INDUSTRIES MACHINERY SYSTEMS, LTD., HYOGO (JP)

(72) Inventors: Joji YUSA, Hiroshima-shi (JP); Hideki FUKUDA, Hiroshima-shi (JP)

(21) Appl. No.: 15/546,494

(22) PCT Filed: Feb. 8, 2017
(86) PCT No.: PCT/JP2017/004538

§ 371 Date: Jul. 26, 2017

(51) Int. Cl. B29D 30/06

(52) U.S. Cl. CPC B29D 30/0605; B29D 30/0662

(57) ABSTRACT

A tire vulcanizer including: a base which supports a lower mold; a beam which supports an upper mold; a tie rod which is disposed to be fixed to one of the base and the beam on one end side thereof and has a plurality of engaged portions provided at predetermined intervals in an axis line direction along an up-and-down direction on the other end side; engaging means which is provided at the other of the base and the beam and engaged with the engaged portion of the tie rod to restrict a movement of the tie rod in the axis line direction; and pressurizing means for pressing the lower mold and the upper mold which are in a mold-closed state, so as to perform mold-clamping.

### RELATED APPLICATIONS

The present application is a National Phase of International Application Number PCT/JP2017/004538 filed Feb. 8, 2017.

### TECHNICAL FIELD

The present invention relates to a tire vulcanizer and particularly to a tire vulcanizer provided with a tie rod clamping mechanism capable of adjusting a mold height.

### BACKGROUND ART

When manufacturing a tire, a tire vulcanizer is used which makes a raw rubber tire (a green tire), molded into a shape close to that of a finished product in advance, into the shape of a completed tire by putting the raw rubber tire in a mold and performing vulcanization treatment by applying heat and pressure.

This tire vulcanizer is provided with an elevating mechanism for moving the mold up and down and a pressurizing mechanism.

The elevating mechanism is for switching the position of the mold between the fully closed position of the mold at the time of vulcanization and the fully opened position of the mold at the time of loading and unloading of the green tire and is configured so as to move the upper mold supported on a beam, a bolster plate, and the like up and down in an up-and-down direction with, for example, a pair of elevating cylinders as a drive source and with a rail as a guide. Further, the elevating mechanism is configured so as to fix the tie rod at the stage where it is fitted to the fully closed position of the mold, thereby holding the clamped mold in this state.

The pressurizing mechanism is for pressing the upper mold or the lower mold at the fully closed position of the mold and pressurizing the green tire in the upper and lower molds during vulcanization. The pressurizing mechanism is configured so as to press the upper mold by pushing the lower mold upward by driving of a doughnut-shaped piston disposed above the base, for example.

On the other hand, in order to cope with a case of replacement with a mold of a different size according to a tire size, a case where a dimensional difference between a cold mold and a preheated and thermally expanded mold or a dimensional difference due to a manufacturing error of a mold occurs, or the like, a mold height adjustment mechanism for adjusting the position of the mold is provided.

As the configuration of this mold height adjustment mechanism, for example, a method of steplessly adjusting the height of a pressurizing plate for pressurizing a mold by a screw mechanism provided at a beam or a base, a method of steplessly adjusting the length of a tie rod by rotating a screw type tie rod, a method of adjusting a height by providing a plurality of grooves for clamping and fixing a tie rod at the fully closed position of a mold in the tie rod and changing the position of the groove at the time of clamping, or the like is used (refer to, for example, PTL 1 to PTL 5).

### CITATION LIST

### Patent Literature

[PTL 1] Japanese Patent No. 3254100

[PTL 2] Japanese Unexamined Patent Application Publication No. 04-332607

[PTL 3] Japanese Unexamined Patent Application Publication No. 05-96547

[PTL 4] Japanese Patent No. 3806247

[PTL 4] Japanese Unexamined Patent Application Publication No. 2000-6153

[PTL 5] German Patent Application Publication No. 19817822

### SUMMARY OF INVENTION

### Technical Problem

However, in a mold height adjustment mechanism using the method of adjusting the height of the pressurizing plate by the screw mechanism provided at the beam or the base or the method of adjusting a height by rotating the screw type tie rod, the height position can be adjusted steplessly. However, the cost of the apparatus increases due to an electric motor or the like being required to rotationally drive the screw mechanism or the screw type tie rod, the pressurizing plate being required separately, and the like.

Further, in a mold height adjustment mechanism using the method of adjusting a height by providing a plurality of grooves in a tie rod and changing a clamping position, as in PTL 5, a pressurizing cylinder having a stroke greater than or equal to a pitch length of the groove of the tie rod is required. That is, the pressurizing cylinder having a long stroke is required, and therefore, the cost of the apparatus increases. Further, in a case where leakage of a working fluid occurs in the pressurizing cylinder having a long stroke, press opening (opening amount) of an upper mold and a lower mold of a tire vulcanizer becomes large according to the large stroke, and thus there is a concern that a green tire may be rapidly scattered to the outside from the gap between the molds caused by the press opening.

Further, even if the position of the groove is determined in accordance with a mold used in a tire manufacturing company such that the pressurizing cylinder having a long stroke becomes unnecessary, an opportune design is made, and thus a design cost increases. Further, the standardization of parts cannot be achieved, and therefore, adverse effects also occur in terms of a cost and a delivery date.

Further, in the mold height adjustment mechanism using the method of adjusting a height by providing a plurality of grooves in a tie rod and changing a clamping position, it is necessary to put a clamping plate in the groove at an appropriate position among the plurality of grooves, and therefore, position control at the time of fully closing of a mold is required.

Further, in a case where clamping is performed at the time of mounting of a cold mold and the mold is then preheated, the engagement portion between the tie rod and the clamping plate is tightened with a strong force due to the thermal expansion of the mold, and thus there is a concern that the clamping plate may not be detached even after release of the pressurizing force.

### Solution to Problem

A tire vulcanizer according to the present invention includes: a base which supports a lower mold; a beam which supports an upper mold; a tie rod which is disposed to be fixed to one of the base and the beam on one end side thereof and has a plurality of engaged portions provided at predetermined intervals in an axis line direction along an up-and-down direction on the other end side; engaging means which is provided at the other of the base and the beam and engaged with the engaged portion of the tie rod to restrict a movement of the tie rod in the axis line direction; and pressurizing means for pressing the lower mold and the upper mold which are in a mold-closed state, so as to perform mold-clamping, and the engaging means includes an engaging member provided so as to be able to advance and retreat in a direction orthogonal to the axis line direction between an engaging position where the engaging member is engaged with the engaged portion of the tie rod to clamp the tie rod and a retracted position where the engaging member is separated from the engaged portion, clamping and holding drive means for switching between an engagement state and a disengagement state of the engaging means with respect to the engaged portion by advancing and retreating the engaging member, a supporting member which supports the engaging means and the clamping and holding drive means with respect to the other of the base and the beam so as to be movable in the axis line direction, and a height adjustment mechanism which advances and retreats the supporting member in the axis line direction within at least a range of a gap between the engaged portions adjacent to each other in the axis line direction.

In the tire vulcanizer according to the present invention, it is preferable that the engaging means and/or the supporting member is disposed with a gap between the engaging means and/or the supporting member and a lower surface of the base or an upper surface of the beam which is the other of the base and the beam, in a state before the tie rod is clamped.

In the tire vulcanizer according to the present invention, it is preferable that the height adjustment mechanism includes a pair of air cylinders disposed back to back with an axis line direction in which a rod advances and retreats being directed in the up-and-down direction, and is configured such that a tip of the rod of the air cylinder on one side is connected to the supporting member and a tip of the rod of the air cylinder on the other side is connected to the other of the base and the beam.

In the tire vulcanizer according to the present invention, it is preferable that a pressurizing force of the air cylinder of the height adjustment mechanism is smaller than a pressurizing force of the pressurizing means.

In the tire vulcanizer according to the present invention, it is preferable that the pressurizing means is a doughnut-shaped pressurizing cylinder.

### Advantageous Effects of Invention

In the tire vulcanizer according to the present invention, a non-step mold height adjustment mechanism using an electric motor or the like and another pressurizing plate become unnecessary, and thus it is possible to attain cost reduction and shortening of a delivery date.

Further, the stroke of a doughnut-shaped piston can be reduced, such as reducing the stroke to 20 mm or less, and therefore, the cost does not increase. Accordingly, there is little danger due to press opening.

Further, in a clamping device having a float mechanism, a gap is always provided between the clamping device and a beam (or a base) before clamping, and therefore, for example, even if the mold thermally expands during clamping, if pressurization is released, a clamp can be removed.

### BRIEF DESCRIPTION OF DRAWINGS

FIG. 1 is a front view showing a tire vulcanizer according to an embodiment of the present invention.

FIG. 2 is a side view showing the tire vulcanizer according to the embodiment of the present invention.

FIG. 3 is a front view showing a clamping and holding mechanism of the tire vulcanizer according to the embodiment of the present invention and is a diagram showing a state where a pair of engaging members is retracted (a state where engagement and clamping are released).

FIG. 4 is a diagram as viewed in the direction of an arrow on line X1-X1 of FIG. 3.

FIG. 5 is a side view showing the clamping and holding mechanism of the tire vulcanizer according to the embodiment of the present invention and is a diagram showing a state where the pair of engaging members is advanced to clamp and hold a tie rod (an engagement state).

FIG. 6 is a diagram as viewed in the direction of an arrow on line X1-X1 of FIG. 5.

FIGS. 7A, 7B, 7C, 7D are diagrams showing each step of adjusting a height using a height adjustment mechanism of the clamping and holding mechanism of the tire vulcanizer according to the embodiment of the present invention.

FIGS. 8A, 8B, 8C, 8D, 8E are diagrams showing each step of adjusting a height using the height adjustment mechanism of the clamping and holding mechanism of the tire vulcanizer according to the embodiment of the present invention and is a diagram showing a difference in engagement state between an engaged portion of the tie rod and engaging means.

### DESCRIPTION OF EMBODIMENTS

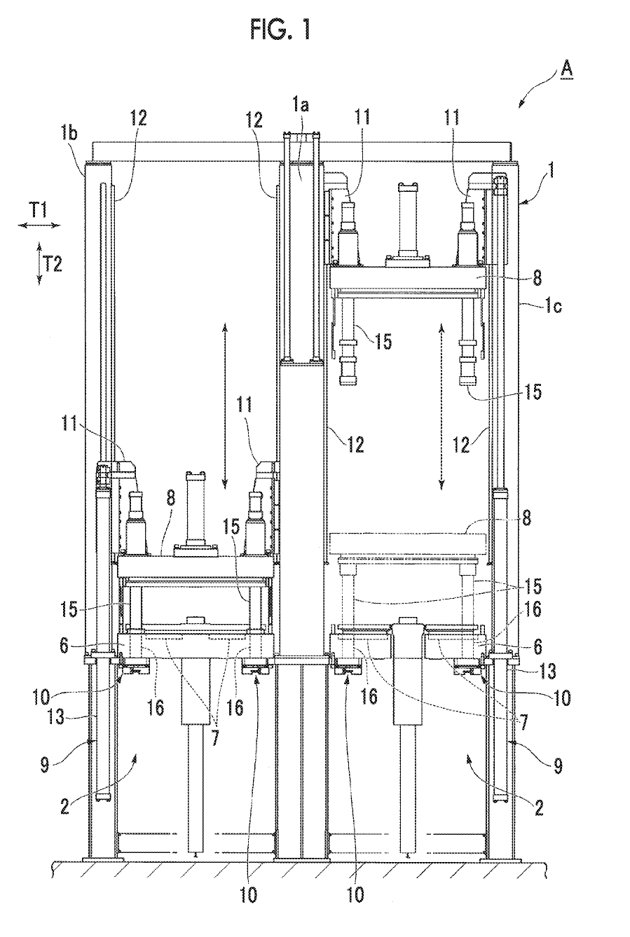

Hereinafter, a tire vulcanizer according to an embodiment of the present invention will be described with reference to FIGS. 1 to 8.

Here, this embodiment relates to a tire vulcanizer for finishing a raw rubber tire (a green tire) molded into a shape close to that of a finished product in advance into the shape of a completed tire by putting the raw rubber tire in a mold and performing vulcanization treatment by applying heat and pressure, at the time of tire manufacturing.

In this embodiment, a tire vulcanizer which is provided with two right and left mold opening and closing devices and in which each of the mold opening and closing devices operates independently will be described as an example. However, the tire vulcanizer according to the present invention does not need to be limited to a configuration having two mold opening and closing devices.

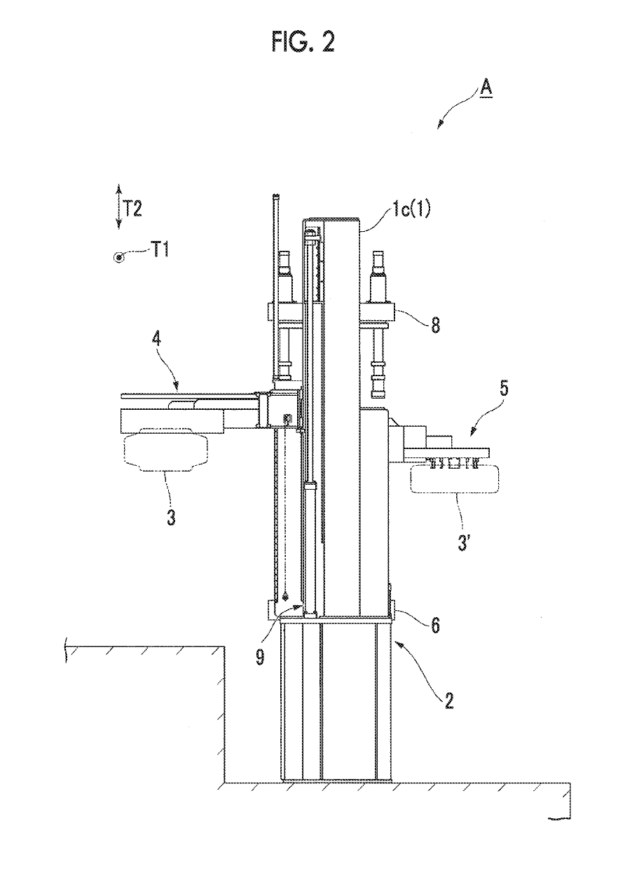

A tire vulcanizer A according to this embodiment is configured to include: a main body frame 1 having a plurality of columns, that is, a central column 1a and a pair of outer columns 1b and 1c, provided to be erect at predetermined intervals in a right-and-left lateral direction T1; two mold opening and closing devices 2 provided on the right and left to be respectively supported by the outer column 1b on one side and the central column 1a and the outer column 1c on the other side and the central column 1a; a pair of right and left loaders 4 for loading a green tire 3 into each of the mold opening and closing devices 2; and a pair of right and left unloaders 5 for unloading a completed tire (a tire finished into the shape of a completed tire) 3′ subjected to vulcanization treatment from each of the mold opening and closing devices 2, as shown in FIGS. 1 and 2. Further, the tire vulcanizer A is provided with a control device for controlling drive of each mechanism or device of the tire vulcanizer A, an operation panel, and the like.

Each of the mold opening and closing devices 2 is provided with: a base (a bolster plate) 6 supported on the outer column 1b or 1c and the central column 1a and fixedly provided horizontally at a predetermined position in an up-and-down direction T2; a heat insulating plate and a heating plate provided at the base 6; a pressurizing mechanism (pressurizing means) 7 for pressing a lower mold on the base 6 upward; a beam (a bolster plate) 8 disposed above the base 6 and the pressurizing mechanism 7 and supported on the outer column 1b or 1c and the central column 1a so as to be able to advance and retreat and to move up and down in the up-and-down direction T2; a heat insulating plate and a heating plate provided at the beam 8; an elevating mechanism 9 for advancing and retreating the beam 8 and an upper mold supported on the beam 8 in the up-and-down direction T2; and a clamping and holding mechanism (a tie rod clamping mechanism) 10 for holding the beam 8 with respect to the base 6 (the upper mold with respect to the lower mold) at a predetermined relative position.

The elevating mechanism 9 is configured to include: a pair of right and left rails 12 provided at each of the outer columns 1b and 1c and the central column 1a, each connected to each of both right and left end portions of the beam 8 through a bracket 11, and advancing and retreating the beam 8 while guiding the beams 8 in the up-and-down direction T2; and an elevating cylinder (elevating drive means) 13 connected to the beam 8 at a tip portion of a rod thereof and extending and contracting in the up-and-down direction T2 so as to advance and retreat the beam 8 in the up-and-down direction T2.

Further, the elevating mechanism 9 includes a pair of right and left tie rods 15 connected to the beam 8 at an upper end portions (one end side) thereof and provided with an axis line thereof being disposed in the up-and-down direction T2, and a pair of right and left tie rod insertion holes 16 which penetrates the base 6 from the upper surface to the lower surface and through each of which the lower end portion side (the other end side) of each tie rod 15 passes when the tie rod 15 advances downward together with the beam 8, and is configured so as to reliably move the beam 8 up and down along the up-and-down direction T2 by the rails 12.

The pressurizing mechanism 7 is provided with, for example, a doughnut-shaped piston (a doughnut-shaped pressurizing cylinder: pressurizing means) provided on the base 6.

On the other hand, the clamping and holding mechanism 10 is integrally provided on the lower surface side of the base 6 to clamp and hold the lower end portion of the tie rod 15 inserted into the tie rod insertion hole 16 and projecting downward from the lower surface of the base 6, and in this embodiment, the clamping and holding mechanism 10 also serves as a mold height adjustment mechanism.

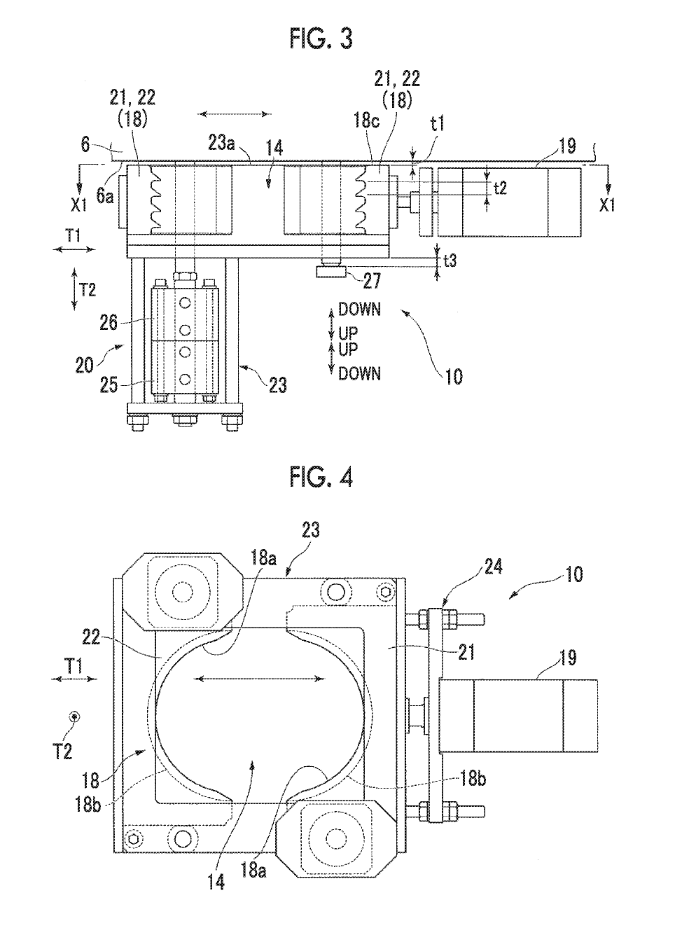

Specifically, the clamping and holding mechanism 10 of this embodiment is configured to include: a plurality of engaged portions 17 provided on the lower end portion side of the tie rod 15; engaging means 18 which is provided so as to be able to be engaged with and released from the engaged portion 17 and holds the lower end portion of the tie rod 15 by being engaged with the engaged portion 17; clamping and holding drive means 19 for causing the engaging means 18 to be engaged with and released from the engaged portion 17; and a height adjustment mechanism 20, as shown in FIGS. 3 to 6 and 8. The engaging means 18 can also be restated as means for restricting the movement of the tie rod 15 in an axis line direction (the up-and-down direction T2) by being engaged with the engaged portion 17 of the tie rod 15.

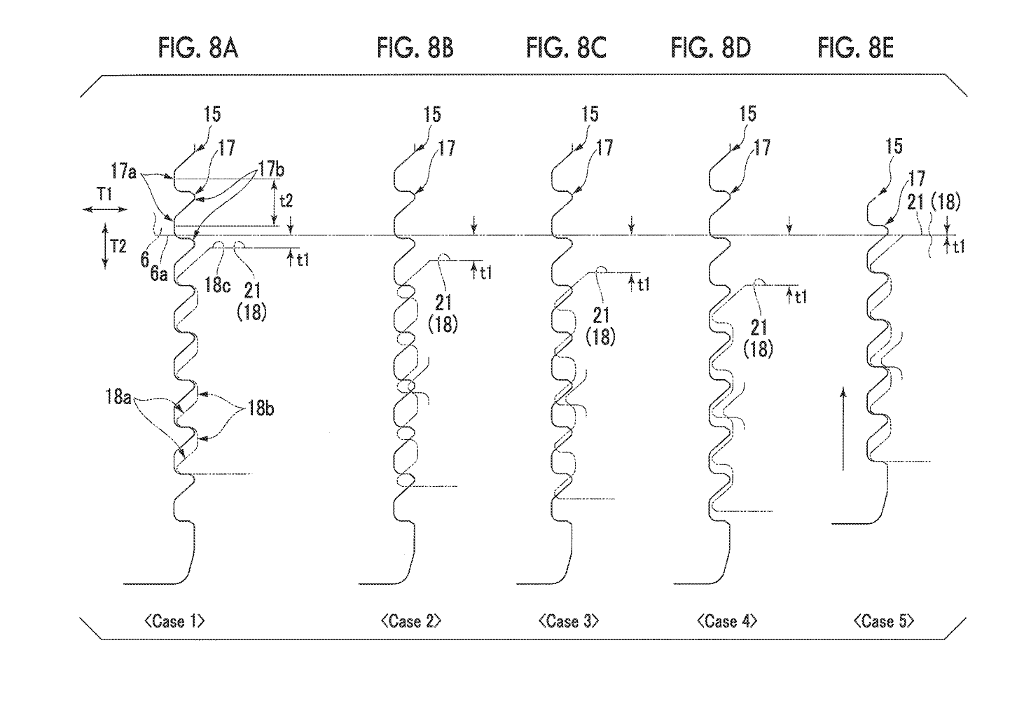

The plurality of engaged portions 17 include a plurality of engaged recesses 17a each annularly connected to extend in a circumferential direction while being recessed radially inward from the outer peripheral surface on the lower end portion side of the tie rod 15 to the axis line center and provided at a predetermined pitch in the axis line direction (T2) (at predetermined intervals in the axis line direction), and a plurality of annular engaged protrusions 17b each provided to alternate with the engaged recess 17a in the axis line direction are formed between the engaged recesses 17a adjacent to each other at a predetermined pitch t2 in the up-and-down direction (refer to FIG. 8(a)). In this way, the outer peripheral surface on the lower end portion side of the tie rod 15 is formed so as to show an approximately saw-blade shape in cross section due to the plurality of engaged portions 17.

The engaging means 18 of this embodiment is formed into a form in which a member formed in a substantially flat plate shape to have, at the center thereof, a concavo-convex-shaped engaging hole 14, which penetrates from the horizontal upper surface to the lower surface and has an inner surface composed of a plurality of stages of (in this embodiment, five-stage) annular engaging protrusions 18a and engaging recesses 18b which are respectively engaged with the engaged recesses 17a and the engaged protrusions 17b of the engaged portion 17 of the tie rod 15, is divided into two parts along the radial direction from the axis line center of the engaging hole 14.

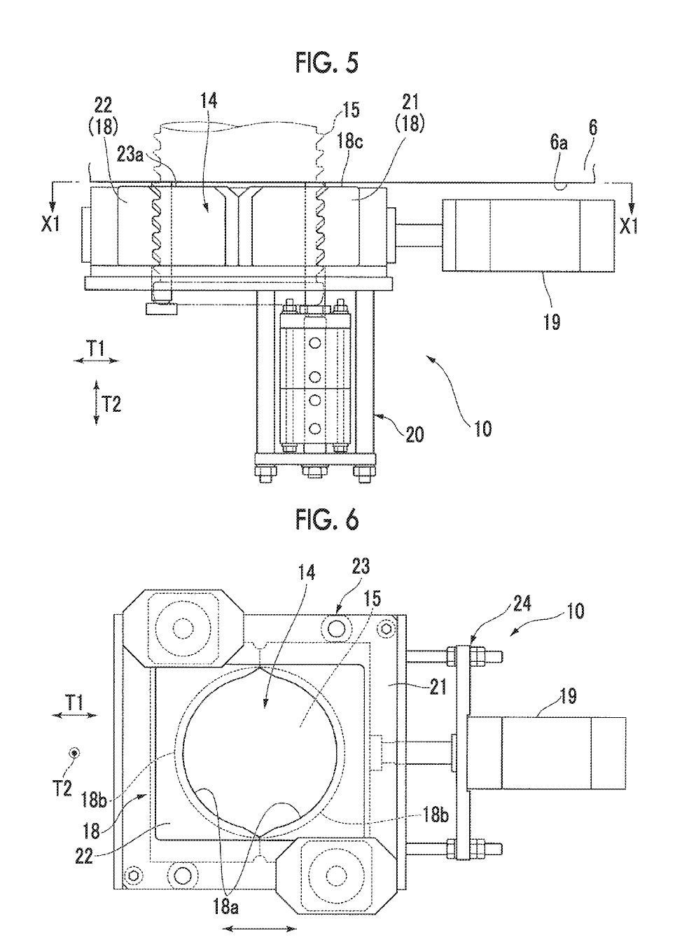

An engaging member 21 on one side and an engaging member 22 on the other side of the form divided into two parts are supported to be mounted on a supporting member 23, which protrudes downward from the lower surface of the base 6, so as to be located horizontally at the same height and to be able to advance and retreat in a horizontal direction. The engaging member 21 on one side and the engaging member 22 on the other side are connected by an interlocking mechanism 24, and if the engaging member 21 on one side advances forward, the engaging member 22 on the other side advances toward the side of the engaging member 21 on one side in conjunction with the advance of the engaging member 21 on one side, and thus the side ends (side surfaces) facing each other come into contact with each other so as to form a circular engaging hole 14 (refer to FIGS. 5 and 6). Further, if the engaging member 21 on one side retracts rearward, the engaging member 22 on the other side retracts so as to be separated from the engaging member 21 on one side in conjunction with the retraction of the engaging member 21 on one side (refer to FIGS. 3 and 4).

In other words, the engaging means 18 of this embodiment is configured by providing the engaging members 21 and 22 so as to be able to advance and retreat in the direction orthogonal to the axis line direction between an engaging position where the engaging members 21 and 22 are engaged with the engaged portion 17 of the tie rod 15 to clamp the tie rod 15 and a retracted position where the engaging members 21 and 22 are separated from the engaged portion 17.

The clamping and holding drive means 19 is an air cylinder, is supported on the supporting member 23 while being connected to the engaging member 21 on one side at the tip of a rod (a piston rod) thereof, and is disposed below the base 6. Compressed air is supplied to and discharged from the clamping and holding drive means 19 that is the air cylinder, and thus the rod advances and retreats in a front-and-back direction, whereby the engaging member 21 on one side and the engaging member 22 on the other side can be advanced and retreated.

Here, the supporting member 23 is horizontally disposed such that an upper surface (an upper end portion) 23a thereof is located below an upper surface (an upper end portion) 18c of the engaging means 18 and faces a lower surface 6a of the base 6. In this way, a predetermined gap t1 is provided between the upper surface 18c of the engaging means 18 and the lower surface 6a of the base 6 in a state where a pair of molds composed of a lower mold and an upper mold is opened. Further, in this embodiment, the gap t1 between the upper surface 18c of the engaging means 18 and the lower surface 6a of the base 6 at the time of mold opening is set to be 4 mm (refer to FIGS. 3, 5, 7(a), and 8(a)).

Further, the engaged portion 17 and the engaging means 18 of this embodiment are formed such that the dimension in the up-and-down direction T2 of one stage, that is, the pitch t2 is 15 mm.

Further, the supporting member 23, the engaging means 18 supported on the supporting member 23, and the clamping and holding drive means 19 are made to be able to be advanced and retreated in the up-and-down direction T2 by the height adjustment mechanism 20.

The height adjustment mechanism 20 is provided with a pair of air cylinders 25 and 26, as shown in FIG. 3, and has a configuration in which the air cylinder 25 on one side is connected to the lower end portion side of the supporting member 23 at the tip of a rod (a piston rod) thereof with the axis line direction thereof beings directed in the up-and-down direction and the air cylinder 26 on the other side is connected to the base 6 at the tip of a rod (a piston rod) thereof with the axis line direction thereof being directed in the up-and-down direction.

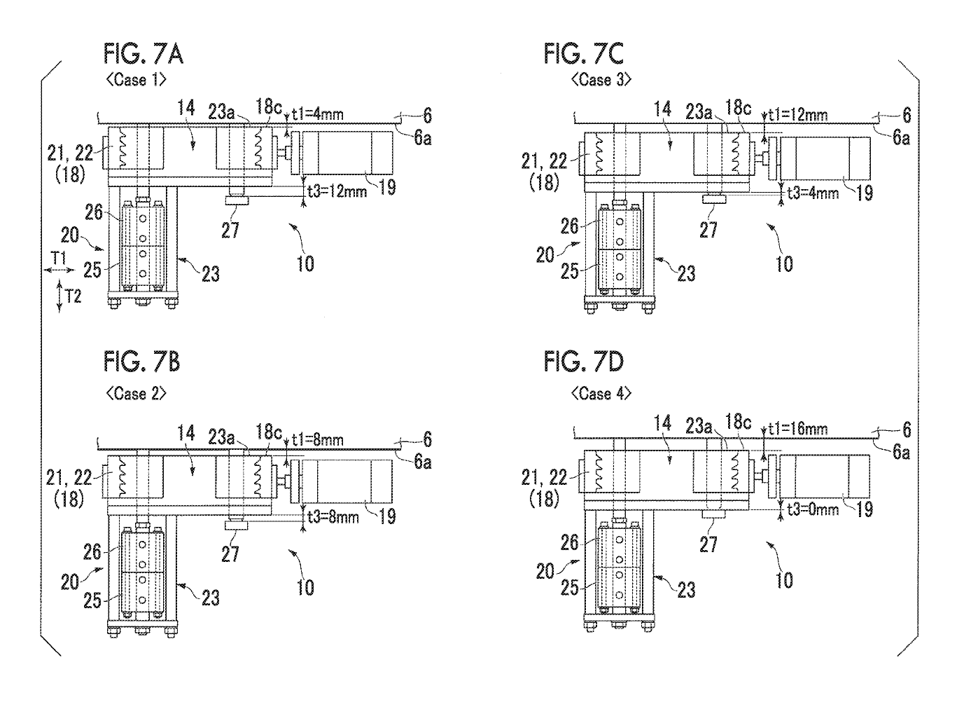

That is, in this embodiment, the height adjustment mechanism 20 is configured such that the pair of air cylinders 25 and 26 are provided back to back (in opposite directions) and the position of the supporting member 23 in the up-and-down direction T2 can be adjusted by a combination of expansion and contraction of the air cylinder 25 on one side and the air cylinder 26 on the other side. In this embodiment, as shown in FIGS. 7 and 8 (Case 1 to Case 4) which will be described later, a configuration is made such that the supporting member 23 can be set to be at four heights by a combination of expansion and contraction of the air cylinders 25 and 26.

As the pair of air cylinders 25 and 26, very short air cylinders each having a stroke amount corresponding to the pitch t2 of the engaged portion 17 are used. In this embodiment, for example, the stroke amount of the air cylinder 25 on one side is set to be 4 mm and the stroke amount of the air cylinder 26 on the other side is set to be 8 mm.

Further, a stopper 27 with which the supporting member 23 retracting downward comes into contact to restrict the downward retraction amount (the lowering amount) of the supporting member 23 is provided. In this embodiment, the stopper 27 is disposed such that a gap t3 of 12 mm which is three times the gap t1 (4 mm) between the upper surface 23a of the supporting member 23 and the lower surface 6a of the base 6 at the time of mold opening is formed between the stopper 27 and the lower surface of the supporting member 23.

An operation when vulcanizing the green tire 3 by using the tire vulcanizer A of this embodiment having the configuration described above will be described.

First, after the green tire 3 is clamped at the loader 4, the loader 4 is raised and rotated to set the green tire 3 in the lower mold on the base 6.

Next, a pressurizing medium such as steam is supplied into the green tire 3 through a bladder, and thus shaping of an unvulcanized tire is performed.

Next, the elevating mechanism 9 is contracted to lower the beam 8, and thus the upper mold held by the beam (the bolster plate) 8 is fitted to the lower mold, so that mold closing is performed. At this time, the four tie rods 15 mounted at diagonal disposition on the beam 8 are respectively inserted into the tie rod insertion holes 16 penetratingly formed in the base 6, and the beam 8 and the upper mold are lowered while being positioned with the rails 12 as guides. In this way, it is possible to suitably fit the upper mold to the lower mold.

Then, at the stage where the upper mold and the lower mold are closed, the lower end portion side of each of the tie rods 15 protruding downward from the lower surface 6a of the base 6 is clamped and held by the clamping and holding mechanism 10.

Specifically, as shown in FIGS. 3 to 6, the engaging member 21 on one side and the engaging member 22 on the other side are horizontally advanced by driving of the clamping and holding drive means 19, whereby the engaging protrusions 18a and the engaging recesses 18b of the engaging member 21 on one side and the engaging member 22 on the other side are engaged with the engaged recess 17a and the engaged protrusion 17b of the saw-blade-shaped engaged portion 17 of the tie rod 15, which protrudes downward from the lower surface 6a of the base 6. The engaging means 18 is engaged with the engaged portion 17 of the tie rod 15 in this manner, whereby the tie rod 15 can be held. This state is also shown in Case 4 of FIG. 8 (d), which is a state where the tie rod 15 can be clamped and held with the engagement of the engaging protrusions 18a and the engaging recesses 18b of the engaging member 21 on one side and the engaging member 22 on the other side.

On the other hand, at the time of the operation of clamping and holding the tie rod 15 with the clamping and holding mechanism 10 of this embodiment, in Case 1 which is a state where the engaging protrusions 18a of the engaging members 21 and 22 are not tightly engaged with the engaged recess 17a of the engaged portion 17 of the tie rod 15, as shown in FIG. 8(a), and Case 2 and Case 3 which are states where the engaging protrusions 18a of the engaging members 21 and 22 collide with the engaged protrusion 17b of the engaged portion 17 of the tie rod 15, as shown in FIG. 8(b), the tie rod 15 cannot be clamped and held.

In Case 1, Case 2, and Case 3, it is necessary to adjust a height position such that the tie rod 15 can be clamped and held, as in Case 4 shown in FIG. 8(d). That is, when clamping and holding the tie rod 15, any one of the states of Case 1, Case 2, Case 3, and Case 4 is always created, and in the case of the state of Case 1, Case 2, or Case 3 due to replacement with a mold of a different size according to a tire size, occurrence of a dimensional difference between a cold mold and a preheated and thermally expanded mold or a dimensional difference due to a manufacturing error of a mold, or the like, it is favorable if the state of Case 1, Case 2, or Case 3 is brought into the state of Case 4.

In contrast, the clamping and holding mechanism 10 of this embodiment is provided with the height adjustment mechanism 20 providing a predetermined gap t1 (in this embodiment, 4 mm) between the base 6 and the engaging means 18 and composed of the air cylinder 25 on one side and the air cylinder 26 on the other side for advancing and retreating the supporting member 23, the engaging means 18, and the clamping and holding drive means 19. Further, the engaged portion 17 and the engaging means 18 are configured with a small pitch t2 of 15 mm.

In the tire vulcanizer A of this embodiment which is provided with the clamping and holding mechanism 10 configured in this manner, if the air cylinder 25 on one side is extended from the initial state shown in FIG. 7(a), the supporting member 23 and the engaging means 18 move downward with respect to the base 6, as shown in FIG. 7(b), and thus the gap t1 between the base 6 and the engaging means 18 is increased to 8 mm and the gap t3 between the stopper 27 and the supporting member 23 is reduced to 8 mm. Further, if the air cylinder 26 on the other side is extended from the state shown in FIG. 7(b) and the air cylinder 25 on one side is contracted, the supporting member 23 and the engaging means 18 further move downward with respect to the base 6, as shown in FIG. 7(c), and thus the gap t1 between the base 6 and the engaging means 18 is increased to 12 mm and the gap t3 between the stopper 27 and the supporting member 23 is reduced to 4 mm. Further, if the air cylinder 25 on one side is extended from the state shown in FIG. 7(c), as shown in FIG. 7(d), the gap t1 between the base 6 and the engaging means 18 is increased to 16 mm and the gap t3 between the stopper 27 and the supporting member 23 becomes 0 mm.

In this way, only by extending the air cylinder 25 on one side or the air cylinder 26 on the other side from the state of Case 1 of FIG. 8(a), it is possible to create the state of Case 4 of FIG. 8(d), where the engaged portion 17 and the engaging means 18 are suitably engaged with each other.

Then, at the stage where the state of Case 4 of FIG. 8(d) is created in this manner and the engaging means 18 of the clamping and holding mechanism 10 is engaged with the engaged portion 17 of the tie rod 15, if the doughnut-shaped piston 7 of the pressurizing mechanism is driven, thereby pressing the lower mold against the upper mold, the pressurizing force is transmitted from the lower mold to the upper mold, from the upper mold to the beam 8, and from the beam 8 to the tie rod 15, and thus the tie rod 15 is displaced upward from the state of FIG. 8(d), as shown in FIG. 8(e) (Case 5).

Along with this, the engaging means 18 with which the engaged portion 17 of the tie rod 15 is engaged is pressed upward, and the upper surfaces 23a and 18c of the supporting member 23 (and the engaging means 18) come into contact with the lower surface 6a of the base 6, and thus the gap t1 disappears and a reaction force is generated. In this way, the engaged portion 17 of the tie rod 15 and the engaging means 18 are firmly engaged with each other, and thus the upper mold and the lower mold can be clamped at a predetermined pressure.

Further, in this embodiment, by allowing the supporting member 23 and the engaging means 18 to advance upward and retreat downward by the pair of air cylinders 25 and 26 provided in the opposite directions and advancing and retreating the supporting member 23 and the engaging means 18 within the range of the pitch t2 of 15 mm of each of the engaged portion 17 and the engaging means 18, the state of Case 4 can be reliably created even in the states of Case 1, Case 2, and Case 3 of FIG. 8, and thus the engaged portion 17 and the engaging means 18 are engaged with each other and the tie rod 15 can be clamped and held.

That is, in the tire vulcanizer A of this embodiment, a height position can be adjusted with a small stroke amount. Further, even in a case where the clamping and holding mechanism 10 is configured to be provided with the saw-blade-shaped engaged portion 17 and the engaging means 18, it is possible to steplessly perform the adjustment of the height position.

Further, the force for pressing the supporting member 23 with the pair of air cylinders 25 and 26 to adjust the height position of the engaging means 18 is sufficiently smaller than the force for clamping the upper mold and the lower mold by driving the doughnut-shaped piston 7 of the pressurizing mechanism.

In this way, even in a case where the gap t1 for height adjustment is provided between the base 6 and the engaging means 18, the upper mold and the lower mold can be clamped, and a configuration can be made such that the gap t1 between the base 6 and the supporting member 23 is eliminated by air being compressed and shrunk due to the extended air cylinders 25 and 26 being pressurized when a pressure caused by the driving of the doughnut-shaped piston 7 necessary for the mold clamping is applied, or by the air cylinders 25 and 26 being automatically contracted due to an operation of a relief valve. Accordingly, the upper mold and the lower mold are clamped and the base 6 and the supporting member 23 are brought into contact with each other to secure a reaction force, and thus it is possible to suitably generate the axial force of the tie rod 15 and thus the pressure of clamping the upper mold and the lower mold.

Therefore, in the tire vulcanizer A of this embodiment, a non-step mold height adjustment mechanism of the related art using an electric motor or the like and another pressurizing plate become unnecessary, and thus it is possible to attain cost reduction, and it is possible to efficiently perform height adjustment with a small stroke.

Further, the stroke of the doughnut-shaped piston 7 can also be reduced, such as reducing the stroke to 20 mm or less, for example, and therefore, also in this regard, it is possible to attain cost reduction.

Further, by reducing the stroke of the doughnut-shaped piston 7, it is possible to keep the amount of press opening of the upper mold and the lower mold very small, even in a case where leakage of a working fluid of the piston 7 occurs. In this way, it is possible to prevent the green tire 3 from scattering from the gap between the molds due to press opening. That is, it is possible to minimize a danger due to press opening.

Further, in the clamping and holding mechanism 10 of this embodiment having the height adjustment mechanism 20, the gap t1 is always provided between the clamping and holding mechanism 10 and the base 6 before clamping, and therefore, for example, even if the mold thermally expands during clamping, if pressurization is released, it is possible to easily remove the clamping (to release the engaged state of the engaged portion 17 with the engaging means 18).

An embodiment of the tire vulcanizer according to the present invention has been described above. However, the present invention is not limited to the above-described embodiment and can be appropriately changed within a scope which does not depart from the gist of the invention.

For example, the tie rod 15 is provided with the lower end portion (the one end side) thereof being connected to the base 6, and the tie rod insertion holes 16 penetrating from the lower surface to the upper surface of the beam 8 are provided in the beam 8. Further, the engaged portion 17 is provided on the upper end portion side (the other end side) of the tie rod 15, and the supporting member 23 is mounted with a predetermined gap t1 between the upper surface of the beam 8 and the engaging means 18. That is, the clamping and holding mechanism 10 and the like are provided in a form inverted upside down from this embodiment. Also in such a configuration, it is possible to obtain the same operation and effect as those in this embodiment.

### INDUSTRIAL APPLICABILITY

According to the tire vulcanizer according to the present invention, a non-step mold adjustment mechanism using an electric motor or the like and another pressurizing plate become unnecessary, and thus it is possible to attain cost reduction, and it is possible to efficiently perform height adjustment with a small stroke.

1. A tire vulcanizer comprising:
a base which supports a lower mold;
a beam which supports an upper mold;
a tie rod which is disposed to be fixed to one of the base and the beam on one end side thereof and has a plurality of engaged portions provided at predetermined intervals in an axis line direction along an up-and-down direction on the other end side;
engaging means which is provided at the other of the base and the beam and engaged with the engaged portion of the tie rod to restrict a movement of the tie rod in the axis line direction; and
pressurizing means for pressing the lower mold and the upper mold which are in a mold-closed state, so as to perform mold-clamping,
wherein the engaging means includes
an engaging member provided so as to be able to advance and retreat in a direction orthogonal to the axis line direction between an engaging position where the engaging member is engaged with the engaged portion of the tie rod to clamp the tie rod and a retracted position where the engaging member is separated from the engaged portion,
clamping and holding drive means for switching between an engagement state and a disengagement state of the engaging means with respect to the engaged portion by advancing and retreating the engaging member,
a supporting member which supports the engaging means and the clamping and holding drive means with respect to the other of the base and the beam so as to be movable in the axis line direction, and
a height adjustment mechanism which advances and retreats the supporting member in the axis line direction within at least a range of a gap between the engaged portions adjacent to each other in the axis line direction.

2. The tire vulcanizer according to claim 1, wherein the engaging means and/or the supporting member is disposed with a gap between the engaging means and/or the supporting member and a lower surface of the base or an upper surface of the beam which is the other of the base and the beam, in a state before the tie rod is clamped.

3. The tire vulcanizer according to claim 1, wherein the height adjustment mechanism
includes a pair of air cylinders disposed back to back with an axis line direction in which a rod advances and retreats being directed in the up-and-down direction, and
is configured such that a tip of the rod of the air cylinder on one side is connected to the supporting member and a tip of the rod of the air cylinder on the other side is connected to the other of the base and the beam.

4. The tire vulcanizer according to claim 3, wherein a pressurizing force of the air cylinder of the height adjustment mechanism is smaller than a pressurizing force of the pressurizing means.

5. The tire vulcanizer according to claim 1, wherein the pressurizing means is a doughnut-shaped pressurizing cylinder.
